(19) United States
(12) Patent Application Publication
(10) Pub. No.: US 2011/0027765 A1
(43) Pub. Date: Feb. 3, 2011

(54) METHODS FOR TREATING SOCIAL DISORDERS

(75) Inventor: Amir Nader, San Diego, CA (US)

Correspondence Address: SUGHRUE MION, PLLC, 2100 PENNSYLVANIA AVENUE, N.W., SUITE 800, WASHINGTON, DC, 20037, US

(73) Assignee: San Diego State University Research Foundation, San Diego, CA (US)

(21) Appl. No.: 12/743,357

(22) PCT Filed: Nov. 17, 2008
(86) PCT No.: PCT/US08/83755

§ 371 Date: Sep. 23, 2010

Related U.S. Application Data
(60) Provisional application No. 60/988,666, filed on Nov. 16, 2007.

(51) Int. Cl. G09B 19/00

(52) U.S. Cl. 434/236

(57) ABSTRACT

Systems and methods for treating patients with an anxiety disorder are disclosed. The systems comprise a screen for displaying sets of stimuli, a computer to control the display of stimuli onto the screen during at least one treatment session and the ability for the patient to interact with the screen in response to the displayed stimuli. The interaction of the patient with the system during the treatment session is capable of treating patient anxiety associated with an anxiety disorder, such as social anxiety. Also provided are computer programs capable of being used in the systems and methods of the present invention for treating anxiety.

### CROSS-REFERENCE TO RELATED APPLICATIONS

This application claims the benefit of U.S. Provisional Patent Application Ser. No. 60/988,666, filed Nov. 16, 2007, entitled “METHODS FOR TREATING SOCIAL DISORDERS,” the contents of which are incorporated by reference in its entirety.

U.S. Provisional Patent Application Ser. No. 60/988,666, hereinafter called “the '666 application”, filed Nov. 16, 2007, titled “METHODS FOR TREATING SOCIAL DISORDERS”

### STATEMENT REGARDING FEDERALLY SPONSORED RESEARCH OR DEVELOPMENT

Part of the work performed during development of this invention utilized U.S. Government funds under NIH contracts R34MH077129 and R34MH07300401. The U.S. Government has certain rights in this invention.

### BACKGROUND OF THE INVENTION

1. Field of the Invention

The present invention relates to systems and methods for treating patients with a social anxiety. The systems comprise a screen for displaying sets of stimuli, a computer to control the display of stimuli onto the screen during at least one treatment session and a means for the patient to interact with the screen in response to the displayed stimuli. The interaction of the patient with the system during the treatment session is capable of treating patient anxiety associated with social settings. The invention also relates to computer programs capable of being used in the systems and methods of the present invention for treating anxiety.

2. Background of the Invention

Anxiety is a physiological state characterized by cognitive, somatic, emotional, and behavioral components. Anxiety is manifested by feelings of fear, apprehension, or worry, and physiologically by heart palpitations, nausea, chest pain, shortness of breath, or headache. Although considered a normal behavior in humans, it can be characterized as a disorder in certain individuals. The four most common types of anxiety disorders are post-traumatic stress disorder (PTSD), generalized anxiety disorder, panic disorder, and social anxiety disorder.

Numerous psychological and biochemical factors are thought to contribute to anxiety disorders. Social anxiety, also known as social phobia, is sometimes thought to be related to an imbalance of the brain chemical serotonin. However, various psychological factors contribute to social anxiety, such as core negative beliefs based on personality and individual negative experiences. Anxiety disorders are still believed to be under-recognized in patients, and usually only diagnosed upon the onset of more severe complications such as depression or substance abuse.

Current treatments of anxiety disorders include medication or a short-term psychotherapy that is known as Cognitive-behavioral therapy. Medications are effective to treat some anxiety disorders, but are costly and often have unwanted side-effects. Typical Cognitive-behavioral therapy techniques, although believed to be effective, usually involve one-on-one direct interaction with a therapist, which requires significant expense and time. Thus, it is desired to develop methods for treating anxiety disorders that allow a patient to undergo treatment sessions that are convenient and easy for a patient and without the need for constant interaction with a therapist.

Cognitive theorists argue that attention processes play an important role in the maintenance of pathological anxiety (e.g., Beck, Emery, & Greenberg, 1985; Mogg & Bradley, 1998; Williams, Watts, MacLeod, & Mathews, 1997). A large body of empirical evidence suggests that anxious individuals selectively attend to threatening information (e.g., Mathews & MacLeod, 2005; Williams et al., 1997). Attentional processes are thought to be particularly important in that attention selectively facilitates the early processing of threat, thereby influencing subsequent cognitive, behavioral, and emotional processes related to anxiety (e.g., Eysenck, 1992; Mathews, 1990; Wells & Matthews, 1994; Williams, Mathews, & MacLeod, 1996). Recently, researchers have attempted to modify experimental tests of attention in order to induce selective processing of threat-relevant versus neutral information. In their landmark study, MacLeod and colleagues demonstrated that it was possible to alter attentional biases using a modified probe detection task by adjusting the contingency between threat-relevant (or neutral) cues and a visual probe (MacLeod, Rutherford, Campbell, Ebsworthy & Holker, 2002). Importantly, training attention toward neutral rather than threat cues resulted in diminished emotional responsiveness to a subsequent stressor.

Contemporary cognitive theories propose that socially anxious individuals are hypervigilant to threatening stimuli that relate to concerns about negative evaluation (e.g., Clark & Wells, 1995; Clark, 2001; Rapee & Heimberg, 1997). These theories suggest that selective attention to threat contributes to the persistence of social anxiety by facilitating preferential processing of negative social information, thereby skewing judgments of social events and ultimately preserving fear-relevant beliefs. Empirical evidence regarding attention bias in social anxiety largely comes from research using the probe detection task (MacLeod, Mathews, & Tata, 1986; see Bögels & Mansell, 2004 for a recent review). In the original probe detection task, participants are shown a pair of words for a short time, one above the other, on a computer screen. One of the words is neutral, and the other is threatening. On critical trials (25% of trials), either the upper or lower word is replaced with a dot probe (•) and participants are asked to press a button to signal the presence of the probe. Faster detection of the probe following threat-relevant stimuli relative to neutral stimuli is thought to reflect biased attention toward threat.

Because a core feature of GSP is a fear of negative evaluation, studies have used the probe detection task with faces to examine attention bias to threat in social anxiety. In support of cognitive models, several studies have found that participants with high levels of social anxiety and patients diagnosed with social phobia were faster to respond to negative (e.g., angry or disgust) faces relative to neutral faces, implying an attention bias toward threat (Mogg & Bradley, 2002; Mogg, Philippot, & Bradley, 2004; Pishyar, Harris, & Menzies, 2004). For instance, Mogg et al. (2004) found that individuals with social phobia selectively attended to angry faces (versus neutral faces) relative to non-anxious controls. Similarly, Gilboa-Schechtman, Foa, and Amir (1999) found that people with social phobia displayed an attention bias towards negative faces using the face-in-the-crowd paradigm. In contrast, several studies have failed to find evidence of attention biases in social anxiety (e.g., Bradley et al., 1997; Chen, Ehlers, Clark, & Mansell, 2002; Mansell, Clark, Ehlers, & Chen, 1999; Pineles & Mineka, 2005). A review of the extant literature suggests that important methodological differences may have in part accounted for these mixed results. Specifically, studies that have demonstrated an attention bias for negative faces in social anxiety have two features in common: 1) they have used face pairs instead of pairing a face with an object (e.g., chair) in the probe detection task and 2) they have presented the faces for 500 ms or less (see Bögels & Mansell, 2004 for a review). These parameters were used in the current study.

In summary, there is evidence for a relationship between attention bias to threat using the probe detection task and social anxiety. However, because of the correlational nature of these studies, it is not possible to examine the causal nature of this relationship. Conclusions regarding the causal role of attention bias in anxiety can only be drawn from experimental designs in which participants are randomly assigned to conditions, their attention is manipulated, and the effect of this manipulation on anxiety is measured. We now turn to this source of evidence.

MacLeod et al. (2002) conducted such a study by screening a large pool of undergraduate students and selecting those who scored in the middle third of the distribution on a self-report measure of trait anxiety. Participants were then randomly assigned to one of two computerized attention training tasks. One program was designed to train the participants' attention toward threat-relevant words (referred to as the “Attend Threat” condition). The second program was designed to train the participants' attention toward neutral words (referred to as the “Attend Neutral” condition). Both programs resembled the original probe detection task described above. Each program consisted of 672 trials in which pairs of words (one neutral, one threat-relevant) were presented, one above the other, on a computer screen. Word pairs were presented for either 20 ms (subliminal) or 480 ms (supraliminal) intervals. In the Attend Threat condition, probes appeared in the position of the threat word on 576 training trials (93%). The remaining 96 trials were designed to provide a measure of attention bias to threat words. In these test trials, threat word position and probe position were fully crossed as in a typical probe detection task, thus permitting measurement of a participant's tendency to attend preferentially to threat-relevant or neutral words. In the Attend Neutral condition, probes appeared in the position of the neutral word on 93% of the trials, with the remaining 96 trials again providing a measure of attention bias. Following completion of one of the two attention training tasks (i.e., Attend Threat or Attend Neutral) participants were told to rest for four minutes. Finally, the authors manipulated the participants' level of stress by presenting them a series of unsolvable anagrams and telling them that this was an intelligence test. Results revealed that participants in the Attend Threat condition showed faster response latencies for detecting probes following threat words than neutral words. Participants in the Attend Neutral condition showed the opposite pattern of results. However, this pattern was only evident for stimuli that were presented long enough to enter conscious awareness (480 ms presentation). Finally, participants in the Attend Threat condition reported more negative affect in response to the experimental stressor than did those in the Attend Neutral condition. These findings suggested that the attention training procedure influenced participants' emotional vulnerability to a subsequent stressor.

Similar results were obtained by Dandeneau, Baldwin and colleagues using a different attention training procedure (Dandeneau, S., & Baldwin, M. W. (2004). The inhibition of socially rejecting information among people with high versus low self-esteem: The role of attentional bias and the effects of bias reduction training. Journal of Social and Clinical Psychology, 23, 584-602.).

Participants were required to locate a single smiling (accepting) face in a grid of frowning (rejecting) faces. In their initial study, they found that participants with low self esteem who were repeatedly required to find a smiling face among frowning faces later showed a reduced attention bias toward rejection words on an emotional Stroop task relative to participants who completed a control task (Dandeneau & Baldwin, 2004). Subsequent work replicated these findings, and further demonstrated that participants completing the attention training task over several days displayed diminished subjective emotional and physiological responsiveness to a real-life stressor (Dandeneau, Baldwin, Baccus, Sakellaropoulo, & Pruessner, 2007). Specifically, students completing the experimental attention training procedure prior to a final exam reported feeling less stressed and more confident about their exam. Similarly, attention training in a group of telemarketers (who routinely experience rejection as part of their work) led to increased self-esteem, lower cortisol levels, lower self-reported stress, higher confidence, and improved work performance. Considered together with the findings of MacLeod et al. (2002), these studies provide the strongest support to date for the hypothesis that individual differences in the allocation of attention to threat-relevant information causally influences one's negative affectivity. At a practical level, these studies suggest that it may be possible to utilize such attention training procedures clinically, that is, training anxious people to direct their attention away from threat information in order to reduce anxiety. Researchers, however, have yet to examine the effects of attention training in a sample of individuals with clinically significant levels of anxiety.

### SUMMARY OF THE INVENTION

The present invention relates to systems and methods for treating patients with a social anxiety. The systems comprise a screen for displaying sets of stimuli, a computer to control the display of stimuli onto the screen during at least one treatment session and a means for the patient to interact with the screen in response to the displayed stimuli. The interaction of the patient with the system during the treatment session is capable of treating patient anxiety associated with social settings.

The present invention also relates to methods of treating anxiety in a patient, with the methods comprising providing an interactive computer program to a subject in need of treatment of anxiety. The interactive programs used in the methods of the present invention are capable of displaying sets of stimuli on a screen to the patient and querying the patient to interact with the screen after the stimuli from each set have been displayed and subsequently removed. The subject is allowed to interact with the interactive program for at least one treatment session, wherein the patient's interaction with the computer program is capable treating the anxiety disorder.

The invention also relates to computer programs capable of being used in the systems and methods of the present invention for treating anxiety. In particular, the invention relates to computer storage media comprising executable code, wherein the executable code is capable of displaying sets of stimuli on a graphical user interface to a user and querying the user to interact with the interface after the stimuli from each set have been displayed and subsequently removed.

### BRIEF DESCRIPTION OF THE DRAWINGS

FIG. 1 depicts one embodiment of a means for displaying a set of stimuli including a computer, a screen, and an keyboard;

FIG. 2 depicts a treatment session according to one embodiment of the invention, depicting a series of stimuli displayed on a screen for a patient to interact with; and

FIG. 3 depicts a chart showing the results over time of treatment sessions according to one aspect of the invention on individuals in an Attention Modification Program (AMP) or an Attention Control Condition (ACC).

### DETAILED DESCRIPTION OF THE INVENTION

The present invention relates to systems and methods for treating patients with anxiety. In one embodiment, the systems comprise a screen for displaying sets of stimuli, a means for controlling the display of the sets of stimuli, and a means for the patient to interact with the screen in response to the displayed stimuli or commands to the patient. The interaction of the patient with the stimuli relieves anxiety.

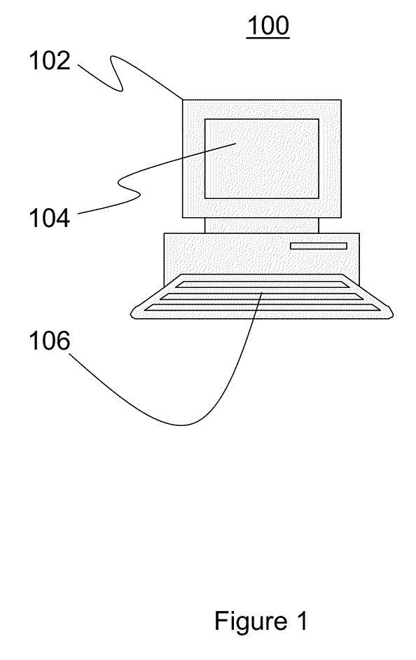

FIG. 1 represents one embodiment of the system 100 of the invention. The system of FIG. 1 comprises a means for displaying sets of stimuli, such as a computer 102, a screen 104 on which the sets of stimuli are displayed, and a tool for interacting with the screen, such as a keyboard 106. Additional examples of means for displaying sets of stimuli to a patient or user include, but are not limited to, human intervention, for example a therapist physically displaying the stimuli to the patient. As used herein, a computer is defined as it would be used in the computer sciences arts. The computer may comprise one or more processors, a memory, a storage device, a display, and an input means.

In one aspect, the system uses the sets of stimuli, such as images or words, to prompt a response by the patient. The patient's response to the stimuli is recorded by the system and stored for analysis and further treatment. The system may then prompt the patient with another set of stimuli based on their response. The stages of presenting sets of stimuli to the patient, recording the patient response, and providing another set of stimuli can be repeated as needed. The system is capable of analyzing the patient response and presenting the patient with new sets of stimuli that aid in the relief of anxiety.

In one embodiment of the invention, the system first probes a patient to create a patient profile of the patient. The probes include a series of questions to assess the level of anxiety in a patient before treatment starts. The answers to the questions are stored in a system memory.

Once the patient has created a patient profile, a treatment session is initiated. An algorithm may analyze the patient profile to determine which treatment session to display to the patient, or the patient may select a specific session on his/her own. The system can provide a plurality of treatment sessions which can, in one non-limiting example, be completed in a specific order. In one treatment session, the system first provides the patient with a set of instructions for completing the treatment session. The patient will read the instructions and then begin the treatment session thereafter.

In one aspect, a treatment session comprises displaying a set of stimuli to the patient. One stimuli is negative, while the other stimuli is neutral. The patient views both the stimuli for a brief period of time, where after the stimuli are removed from the display. The patient is then prompted to interact with the system by inputting a response that is correlated with one of the previously displayed stimuli in the set of images. Once the patient provides a response, a second set of stimuli is displayed to the user for a similarly brief period of time, after which the patient is again prompted to input a response. In one aspect, the response is limited to one of two choices given to the patient, such as a left or right click of a mouse, or the input of a specific letter on a keyboard. The treatment session continues as described by briefly displaying a neutral and negative stimuli, and then prompting the patient for a response for any amount of time until the session is deemed completed. In one embodiment, the length of the session is typically predetermined by the system, but it could also be determined based on the patient's responses.

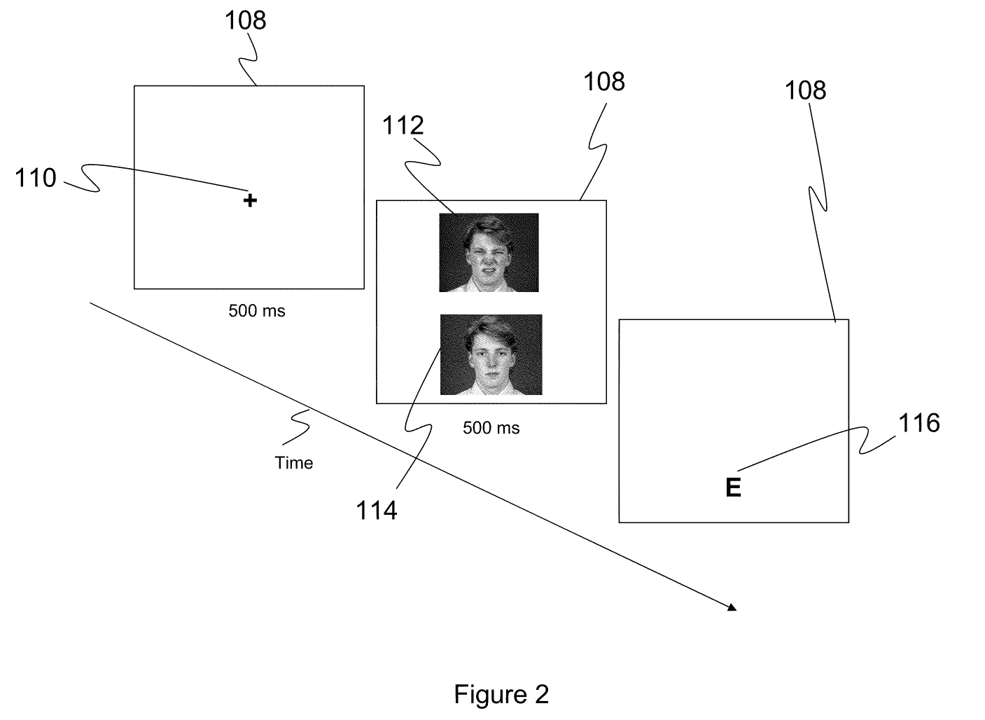

In one embodiment representing a system for treating patients with social anxiety, the set of stimuli displayed comprise images of people, such as photographs, as depicted in FIG. 2. The patient is first presented with a display screen 108 without the images, containing only a first symbol 110 positioned between the images to be later displayed. In the embodiment shown in FIG. 2, the first symbol 110 is a fixation cross. The patient is asked to focus on the fixation symbol, which subsequently disappears and is replaced by two images simultaneously displayed above and below the symbol 110 sign as a top image 112 and a bottom image 114. The patient is instructed to focus on one of the images, such as the top image 112, for the first set of images displayed. In the embodiment shown in FIG. 2, the top image 112 is a negative stimuli, and shows a person with a negative facial expression, while the bottom image 114 is a neutral stimuli, and shows a person with a neutral or emotion-less expression. The images then simultaneously disappear after a short period of time—approximately 500 milliseconds in one embodiment—and a second symbol, or probe 116 appears where one of the images was previously positioned. The probe 116 corresponds to a response that the patient is instructed to provide. In the embodiment of FIG. 2, the probe is either the letter “E” or the letter “F.” The patient is instructed to respond in a specific manner depending on which probe 116 appears—if the “E” appears, the patient can press the left button on a mouse, and if an “F” appears, the patient can press the right button on the mouse.

The system, through the selection of specific stimuli and the placement of the probe 116, helps to train the patient to focus away from the negative stimuli, thereby eliminating attention bias and leading to the reduction in anxiety associated with an anxiety disorder through methods that will be described in more detail below.

In one aspect of the invention, the patient is provided with instructions prior to beginning the therapy session; however, in another aspect, the instructions can be provided during the treatment session.

In another embodiment of the system for treating patients with social anxiety, the images of people are replaced with words. As with the images, two words are displayed simultaneously, with one word having a negative connotation and the other word having a neutral connotation. The patient is then prompted to interact with the system as described before—by responding in a specific manner depending on which symbol appears after the words are displayed.

One skilled in the art will appreciate that the set of stimuli is not limited to two, and a plurality of images or words may be presented to the user to effectuate a therapeutic result.

Once the patient completes a therapy session, the patient's interactions with the system during the therapy session are stored in the system memory. The stored interactions can then be accessed by a health professional, such as the patient's therapist, for analysis. The system can also use the stored interactions to determine the next treatment session that should be presented to the patient. This determination is based on an algorithm that utilizes the stored interactions to determine a proper treatment session to present to the patient. Additionally, in alternate embodiments, the patient or the health professional can select the next treatment session. The selection can be done at the computer or display screen itself, or remotely, such as a health professional who receives the stored interaction data at a remote location and then transmits back instructions to the system or the patient for which treatment session to perform next.

The patient can interact with the system through a variety of devices, including but not limited to a mouse, keyboard, stylus, pen light, or laser. Additionally, the system can be configured to respond to the patient's touch, such as with a touch screen display device, or to respond to the patient's eye movement, head movement, or voice. Additional software and hardware may be needed to accomplish the various methods of interacting with the system described herein.

In one embodiment, the user or the algorithm can change the time during which the images are displayed. In specific embodiments, the images are displayed at least about 50 ms, at least about 50 ms to about 100 ms, at least about 100 ms to about 200 ms, at least about 200 ms to about 300 ms, at least about 300 ms to about 400 ms, at least about 400 ms to about 500 ms, at least about 500 ms to about 600 ms, at least about 600 ms to about 700 ms, at least about 700 ms to about 800 ms, at least about 800 ms to about 900 ms, at least about 900 ms to about 1 second. In one specific embodiment, the images are displayed about 500 ms

The system also comprises numerous self-assessments and evaluation tools for the patient to keep track of his/her progress during the treatments. The tools include, in one aspect, electronic forms to fill out to evaluate the level of perceived anxiety, or questions to answer regarding the level of anxiety felt. The questions and forms are displayed, in one aspect, on the computer display by the computer that is running the system. The information gathered from these additional tools is also stored in the system and can be used by a health care professional or a therapist to review the patient's progress. Additionally, the system can assess the data on its own using algorithms to measure and display progress, and show the patient or therapist the progress that is being made.

### I. Study

In one embodiment, a study was conducted using a 2 (Group)×2 (Time: pre-test, post-test) mixed design. Participants were randomly assigned to an Attention Modification Program (AMP, n=17) or an Attention Control Condition (ACC, n=17). They were assessed using self-report and interviewer measures before and after eight sessions of training. Additionally, all participants in the AMP condition were assessed once more approximately 4 months after the post-assessment in order to examine the longevity of any symptom change.

The faces used in this probe detection task were selected from a standardized set of emotional expressions (Matsumoto, D. & Ekman, P. (1989). The Japanese and Caucasian Facial Expressions of Emotion (JACFEE) and Neutrals (JACNeuF). San Francisco, Calif.: Intercultural and Emotion Research Laboratory, Department of Psychology, San Francisco State University). The set includes eight individuals (four male, four female) displaying disgust (or negative) expressions, and neutral expressions.

Attention Modification Program (AMP)

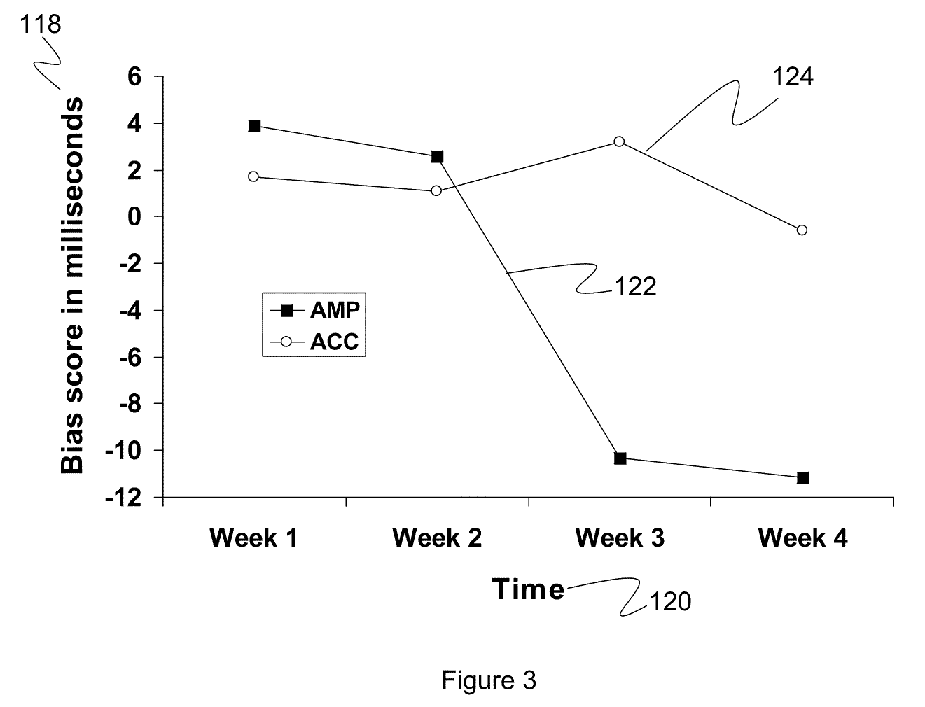

Participants assigned to the AMP condition received a computer delivered attention training protocol. The AMP protocol included eight 20-minute sessions delivered over a four week period (i.e., twice weekly sessions). During each session, as illustrated in FIG. 2, participants completed a probe detection task that began with a fixation cross 110 presented for 500 ms. The computer then presented participants two faces of the same individual, one face on top 112 and one on bottom 114, with combinations of two emotions (i.e., neutral and disgust, or neutral and neutral). After 500 ms, a probe 116 (either the letter “E” or the letter “F”) appeared in the location of one of the two faces. The participants were instructed to decide if the letter was an E or an F by pressing the corresponding button (left or right) on the computer mouse. The probe 116 remained on the screen 108 until participants responded. The next trial began as soon as participants responded. Participants were told that it was important that they perform the task as quickly as possible without sacrificing accuracy. In previous research using this paradigm, it was found that participants' average accuracy to be 95% or higher. The results of one trial are illustrated in the chart in FIG. 3, where the bias score 118 over time 120 of the group of AMP participants 122 is plotted against the bias score of the group of ACC participants 124. The chart clearly shows the reduction in attention bias amongst the AMP group participants 122 over a period of four weeks, with the most significant drop between Week 2 and Week 3.

During each session, AMP participants saw 160 trials that consisted of various combinations of probe type, probe position, emotion type, and face (four male and four female faces). Of the 160 trials, 128 trials (i.e., 80% of trials) included one neutral face and one disgust face [2 (E or F)×2 (top or bottom)×8 (faces)×4 (repetition)]. During these neutral-disgust trials the probe always replaced the neutral face. The remaining 32 trials (i.e., 20% of trials) included only neutral faces [2 (E or F)×2 (top or bottom)×8 (faces)]. Thus, although there was no specific instruction to direct attention away from disgust faces, on 80% of all trials the position of the disgust face determined the position of the probe (i.e., in the location opposite the disgust face).

Attention Control Condition (ACC)

The ACC was identical to the AMP procedure except that during the presentation of the trials where a disgust face was present (i.e., neutral-disgust trials), the probe appeared with equal frequency in the position of the disgust face and the neutral face. Therefore, of the 160 trials, 64 trials (i.e., 40% of trials) were neutral-disgust with the probe following the disgust face, 64 trials (i.e., 40% of trials) were neutral-disgust with the probe following the neutral face, and the remaining 32 trials (i.e., 20% of trials) included only neutral faces as in the AMP. Thus, neither the disgust face nor neutral face had signal value regarding the position of the probe.

After completing eight sessions of AMP or ACC, participants completed a post-assessment identical to the pre-assessment. Finally, participants in the AMP group were invited to complete follow-up assessments, which occurred approximately 4 months later.

Attention Bias Index

To examine the effect of the computerized training on participants' attention bias, response latencies were compared for trials that consisted of two neutral stimuli (N-N trials) with response latencies for trials that comprised one neutral and one disgust face (N-D trials). Enhanced ability to disengage attention from threat would result in faster response latencies when responding to a probe following a neutral face in the N-D trials compared to responding to a probe following a neutral face in the N-N trials (see Koster, Crombez, Verschuere, & Houwer, 2004). Participants in the AMP group saw twice as many N-D trials with the probe following the neutral face than those in the ACC because of the nature of our training contingency. Therefore, to compare the same number of response latencies across groups the results were compared for the first 16 trials of this type in each group. These values were compared to the N-N trials (16 trials) from both groups.

Statistical Analyses

Consistent with previous treatment outcome studies of social anxiety, analyses of covariance (ANCOVAs) were conducted on post-treatment scores, controlling for pre-treatment scores (e.g., Heimberg, R. G., Liebowitz, M. R., Hope, D. A., Schneier, F. R., Holt, C. S., Welkowitz, L. A., et al. (1998). Cognitive behavioral group therapy vs. Phenelzine therapy for social phobia. Archives of General Psychiatry, 55, 1133-1141).

Results

To ensure that random assignment did not create groups differing in demographics or measures of anxiety and depression at pre-treatment, t-tests were conducted comparing groups at pre-treatment on various measures. This analysis revealed that groups did not differ significantly at pre-treatment on any of the measures (ps>0.2).

Interviewer Measures

At post-treatment, the AMP group had significantly lower scores than the ACC group on the Liebowitz Social Anxiety Scale (LSAS), F(1, 31) =14.15, p<0.001, when pre-treatment scores were partialled out. Moreover, the AMP group had significantly lower functional impairment scores at post-treatment compared to the ACC group on the Sheehan Disability Scale, F(1, 31)=5.38, p<0.03, when pre-treatment scores were partialled out. However, groups did not differ on their Hamilton depression scores at post-treatment controlling for pre-treatment scores, F(1, 31)=0.25, p=0.46.

Diagnostic status after treatment was also examined. These data revealed that a significantly higher proportion of the participants in the AMP group (44%) no longer met diagnostic criteria for social phobia compared to the ACC group (13%), X²(1)=4.03, p<0.05.

Self-Report Measures

At post-treatment, the AMP group had significantly lower scores than the ACC group on the Social Phobia and Anxiety Inventory (SPAI), F(1, 31)=4.14, p<0.05, when pre-treatment scores were partialled out. However, groups did not differ on their BDI [F(1, 31)=0.08, p=0.77], STAI-S, [F(1, 31)=0.29, p=0.59, or STAI-T [F(1, 31)=0.37, p=0.55] at post-treatment controlling for pre-treatment scores.

Magnitude of Effect

To examine the magnitude of improvement in symptoms, effect sizes were calculated (d=pre score−post score/pooled standard deviation) for each group. In line with Cohen's (1988) suggestion, the effect size for the LSAS in the AMP group was classified as large, d=1.32 (Cohen, J. (1988). Statistical power analysis for the behavioral sciences. (2nd ed.). New York: Lawrence Erlbaum Associates). The effect size for the ACC group was small, d=0.43.

Follow-Up

Follow-up data was collected for four months following the termination of the training sessions for participants assigned to the AMP group. 16 follow-up assessments for 17 participants (94%) in the AMP group were collected. Scores on most interviewer measures as well as self-report measures show a downward trend. Participants' LSAS scores at follow-up were not significantly different from their post, t(15)=1.56, p=0.10. However, participants' LSAS scores at follow-up were significantly lower than their pre-treatment scores, t(15)=5.20, p<0.001. Similarly, participants' SPAI scores at follow-up were not significantly different from their post, t(15)=1.15, p=0.27. However, participants' SPAI scores at follow-up were significantly lower than their pre-treatment scores, t(15)=3.30, p<0.01. Thus, the decrease in symptoms after training appears to be a lasting effect.

Change in Attention Bias

Participants' response latencies on the probe detection task were submitted to a 2 (Group: AMP, ACC)×2 (Trial type: neutral-neutral, neutral-disgust)×4 (Week: one, two, three, four) ANOVA with repeated measurement on the last two factors. This analysis revealed a significant main effect of Week [F(3, 96)=41.14, p<0.01] that was modified by a significant interaction of Group X Week X Trial type [F(3, 96)=5.60, p<0.02]. None of the other effects were significant (ps>0.2). To explore this 3-way interaction further, separate 4 (Week)×2 (Trial Type) ANOVAs were conducted in the AMP and the ACC group.

To simplify the analysis a bias score was calculated by subtracting participants' response latencies for neutral-disgust trials where the probe followed the neutral face from response latencies for neutral-neutral trials. To ensure that the same number of trials was used for both groups, only the first 16 neutral-disgust trials were included in each group (see Procedure section). A positive score on this index implies difficulty disengaging attention from threat.

These bias scores were submitted to a 2 Group×4 Week (1, 2, 3, 4) ANOVA with repeated measurement on the second factor. These analyses revealed a main effect of Week [F(3, 96)=8.23, p<0.007] that was modified by an interaction of Group X Week [F(3, 96)=5.99, p<0.02]. The main effect of Group was not significant [F(1, 32)=1.80, p=0.19]. To probe this interaction, a simple effects analysis was conducted. Simple effect of Group revealed that the AMP and the ACC did not differ in their bias score during week 1 [t(32)=0.32, p=0.75] or week 2 [t(32)=0.22, p=0.82]. However, participants in the AMP had significantly lower bias scores than the ACC group during week 3 [t(32)=2.29, p<0.03] and week 4 [t(32)=2.63, p<0.01]. Simple effect of Week revealed that in the AMP group there was significant linear decrease in bias scores across time [F(1, 16)=8.67, p<0.01]. However, the ACC group did show a change in bias across time [F(1, 16)=8.23, p<0.007]. These data are depicted in FIG. 3.

Correlational Analyses

Group membership was correlated with attention bias during week 4 (r=0.42, p<0.01). Moreover, attention bias during week 4 was correlated with change in anxiety on the LSAS (r=0.34, p<0.05).

Discussion

As predicted, attention training successfully changed attention to threat, as well as symptoms of social anxiety in individuals diagnosed with Generalized Social Phobia. At post-treatment, independent assessors rated participants completing attention training as significantly less socially anxious and less functionally impaired than the control group. Further, participants' self-report of social anxiety symptoms corroborated interviewer ratings. Finally, 44% of participants in the AMP condition no longer met DSM-IV criteria for social phobia after training, compared to 13% of participants in the control condition.

Information processing measures corroborated the findings from interviewer and self-report measures. Specifically, the AMP group showed a decrease in bias for threat over the course of the study. The present work expands the extant literature, however, in serving as the first study to successfully manipulate attention processes using a computerized procedure in a sample of clinically anxious patients.

Several explanations may account for the reduction in social anxiety associated with attention training. Previous research indicates that socially anxious individuals preferentially process negative social information (e.g., Gilboa-Schechtman et al., 1999; Veljaca & Rapee, 1998). To the extent that attention biases toward threat are causally involved in the maintenance of anxiety (e.g., MacLeod et al., 2002), then any procedure that normalizes this bias would be expected to also reduce anxiety symptoms. Consistent with this hypothesis, participants in the AMP group displayed a reduction in attention bias to threat-relevant cues over the course of treatment. In keeping with findings from previous work, it may be that the attention training procedure reduced participants' emotional vulnerability in the context of real-life social encounters (e.g., Dandeneau et al., 2007; MacLeod et al., 2002).

The current research represents the first study to assess the long-term impact of an attention training procedure on anxiety. Follow-up assessments revealed that participants maintained symptom reduction for 4 months on average after completing the training. Notably, this maintenance of gains occurred in the absence of booster sessions or further contact. Those findings suggested that the beneficial effects of the attention training program were enduring.

The system described herein is discussed with relevance to the treatment of social anxiety, but treatment of other anxiety-related disorders is also possible. This includes, but is not limited to, post-traumatic stress disorder (PTSD), general anxiety disorder, panic disorder, and social anxiety disorder.

### II. Computer Program Aspects

The computer where the system resides may also comprise a main memory, a random access memory (RAM), and, optionally a secondary memory. In the computer used to implement the method and programs of the present invention, storage for the programs is provided by the main memory and/or the secondary memory.

Examples of secondary memories include, but are not limited to, for example, a hard disk drive and/or a removable storage drive, representing a floppy disk drive, a magnetic tape drive, a compact disk drive, a DVD drive, a flash drive, etc. The removable storage drive may read from and/or write to a removable storage unit in a well-known manner.

Removable storage unit, also called a program storage device or a computer program product, represents a floppy disk, magnetic tape, compact disk, a DVD a flash drive, etc. As will be appreciated, the removable storage unit may also comprise a computer usable storage medium having stored therein computer software (programs) and/or data.

Computer programs can be stored in main memory and/or the secondary memory. Such computer programs include, for example, computer programs corresponding to the applications. These computer programs, when executed in their respective computers, enable the processors in those computers to perform the methods and features of the present invention. Accordingly, such computer programs represent controllers of their respective computers.

In one aspect of the invention, the computer that controls the display of stimuli is local to the patient, but in another aspect, the computer can be located at a remote location, such that the patient only has access to the display and a means for interacting with the computer, such as a mouse or keyboard. The use of a remote computer may be suited for a study where a patient is in a different location than a therapist, so that the patient may undergo a treatment session while the computer is in a location with the therapist who is more frequently accessing and reviewing the patient's stored interactions and patient profile. The patient profile may also be more secure on a remote computer as opposed to a computer that is local to the patient.

In another embodiment, the screen on which the stimuli are displayed can be a computer monitor. Namely, a computer to control the display of stimuli onto the screen during at least one treatment session and a means for the patient to interact with the screen in response to the displayed stimuli. The interaction of the patient with the system during the treatment session is capable of treating patient anxiety associated with social settings.

The present invention also relates to methods of treating an anxiety disorder in a patient, with the methods comprising providing an interactive computer program to a subject in need of treatment of anxiety. The interactive programs used in the methods of the present invention are capable of displaying sets of stimuli on a screen to the patient and querying the patient to interact with the screen after the stimuli from each set have been displayed and subsequently removed. The subject is allowed to interact with the interactive program for at least one treatment session, wherein the patient's interaction with the computer program is capable treating the anxiety disorder.

The invention also relates to computer programs capable of being used in the systems and methods of the present invention for treating anxiety. In particular, the invention relates to computer storage media comprising executable code, wherein the executable code is capable of displaying sets of stimuli on a graphical user interface to a user and querying the user to interact with the interface after the stimuli from each set have been displayed and subsequently removed.

The present invention may be implemented using hardware, software or a combination thereof and may be implemented in a computer system or other processing system. Various software implementations are described in terms of this exemplary computer system. After reading this description, it will become apparent to a person skilled in the relevant art how to implement the invention using other computer systems and/or computer architectures.

1. A system for treating patients with an anxiety disorder, the system comprising:
a screen for displaying sets of stimuli,
a computer to control the display of stimuli onto the screen during at least one treatment session,
a means for the patient to interact with the screen in response to the displayed stimuli,
wherein the interaction during the treatment session relieves patient anxiety associated with an anxiety disorder.

2-7. (canceled)

8. The system of claim 1, wherein the computer that controls the display of stimuli onto the screen is remote to the patient.

9-11. (canceled)

12. The system of claim 8, wherein a patient's therapist can access the stored interactions of the patient for each treatment session.

13-14. (canceled)

15. The system of claim 1, wherein the sets of stimuli comprise at least two stimuli.

16. (canceled)

17. The system of claim 15, wherein at least one stimuli is a negative stimuli and at least one stimuli is a neutral stimuli, and wherein the stimuli within each set of stimuli are displayed simultaneously to the patient.

18. (canceled)

19. The system of claim 17, wherein the screen displays the stimuli for approximately 500 milliseconds.

20. The system of claim 19, wherein the stimuli is an image.

21. (canceled)

22. The system of claim 20, wherein the image is a photograph of individual people with a facial expression.

23. The system of claim 22, wherein the computer probes the patient to interact with the screen after the stimuli have been displayed and subsequently removed from the display.

24. The system of claim 23, wherein the computer probes the patient to interact in an area on the screen where at least one of the previously displayed stimuli was displayed.

25. The system of claim 24, wherein the computer probes the patient to interact in an area on the screen where the neutral stimuli was previously displayed.

26. The system of claim 25, wherein the screen displays a subsequent set of stimuli on the display, after the patient has interacted in response to the probe.

27-55. (canceled)

56. A computer program product for treating patients with an anxiety disorder, comprising program code means which when executed by a computer carry out the following steps:
displaying sets of stimuli on a graphical user interface to a user; and
querying the user to interact with the interface after the stimuli from each set have been displayed and subsequently removed, wherein the interaction relieves patient anxiety associated with an anxiety disorder.

57-61. (canceled)

62. The computer program product of claim 56, wherein at least one stimuli is a negative stimuli and at least one stimuli is a neutral stimuli, and wherein the stimuli within each set of stimuli are displayed simultaneously to the patient.

63. The computer program product of claim 62, wherein the screen displays the stimuli for approximately 500 milliseconds.
